(19) United States
(12) Patent Application Publication
(10) Pub. No.: US 2007/0109255 A1
(43) Pub. Date: May 17, 2007

(54) Method and Apparatus for Display

(76) Inventors: Suibin Zhang, Belmont, CA (US); Yuan Yue Zhang, Belmont, CA (US)

Correspondence Address: SUIBIN ZHANG, 2443 HASTINGS DR., BELMONT, CA, 94002, US

(21) Appl. No.: 11/558,899

(22) Filed: Nov. 11, 2006

Related U.S. Application Data
(60) Provisional application No. 60/736,232, filed on Nov. 15, 2005.

(51) Int. Cl. G09G 3/34

(52) U.S. Cl. 345/110

(57) ABSTRACT

A display apparatus includes a conveyor base to carry a plurality of display stripes having a plurality of light emitting elements to form one or more planar display surfaces when the conveyor base travels around two or more rotating shafts, a power supply to supply constant power to the display stripes while the stripes travel with the conveyor base, a controller system that processes the desired image information and communicate with the display stripes thereby providing means for controlling the light emitting elements in accordance with the rotation speed of the shafts. The method to form the display is also described as exemplified by the apparatus.

### BACKGROUND OF THE INVENTION—FIELD OF INVENTION

This invention relates to an electronic display method and device, specifically using a mechanical scanning method to achieve a display resolution greater than the number of light emitting elements involved.

### BACKGROUND OF THE INVENTION—PRIOR ART

Lighting elements, such as Light Emitting Diode (LED), have been arranged in dot matrixes for use of displaying text and graphic information. One of the biggest advantages of using LEDs compared with other display methods, such as plasma, liquid crystal and conventional Cathode Ray Tube (CRT,) is that LED display has high brightness, and dot matrix can be constructed to a large display area most suitable for indoor and outdoor advertisement. The dot-matrix construction of a display, however, inherently requires large amount of light elements when a high resolution and/or large display area is required. Hence the cost such a construction go up with higher resolution and/or larger area. High resolution and large display area are desirable display features for advertisement or information dissimulation. For example, a VGA resolution of such a display has 640×480 pixels. Over 900,000—640 times 480 times 3, LEDs are needed for such a display if each pixel consists of one of each of red, green and blue LEDs.

Improvements had been made to reduce the number of lighting elements needed, such as described by Wang in U.S. Pat. No. 5,818,401. Wang describes a display by mounting lighting elements on a rotating cylindrical body so that each vertical line of LEDs is responsible for displaying multiple lines of pixels so that fewer number of LEDs are used than that the resolution commands. However, such an implementation has a number of limitations. For example, a display based on U.S. Pat. No. 5,818,401 has a cylindrical and curved display surface that is less desirable than a flat displaying surface. Such a display device also occupies large real estate to install because the footprint needed is about 3.14 (Pi) times the square of the radius of the rotating cylinder.

The present invention involves a method of display that overcomes the disadvantages described above. Such a display apparatus employs mechanical and electronic methods to achieve higher resolution, lower cost, and large area of planar display surface, compared with the above and the conventional methods.

### BRIEF DESCRIPTIONS OF THE DRAWINGS

FIG. 1 is a schematic view of the first embodiment of display apparatus according to the present invention.

FIG. 2 is a schematic view of the display stripe according to the present invention.

FIG. 3 is a schematic view of an embodiment of making electrical contacts between the power supply and the display stripes.

FIG. 3b is a schematic view of an alternative embodiment of making electrical contacts between the power supply and the display stripes, in accordance with the present invention.

FIG. 4 is a block-diagram view of the display controller system in accordance with the present invention.

FIG. 5 is a block-diagram view of the controller circuitries on the display stripes in accordance with present invention.

FIG. 6 illustrates the method of using mechanical scanning to form a display in a time-space relationship in accordance to the present invention.

### SUMMARY OF PRESENT INVENTION

The present invention involves a method and apparatus to render graphic or text information on an electronic display. This method comprises of moving a conveyor base wrapped around two or more rotating shafts. The shafts are stationary mounted and are driven by a motor assembly to rotate at a desired speed, thereby the conveyor base also travels around the rotating shafts. A plurality of display stripes comprising of light emitting elements are harnessed on the conveyor base. The method further comprises of supplying constant power to the display stripes and a wireless means to communicate information between the display stripes and a stationary mounted display controller system. As the display stripes travel with the conveyor base, information is displayed accordingly in a controlled manor to render an image with resolution higher than the number of light emitting elements involved.

The preferred embodiment of the apparatus, as in the present invention, using this method is described in detailed and also as an illustration of the method in the present invention.

### DETAILED DESCRIPTION OF THE METHOD AND THE PREFERRED EMBODIMENTS

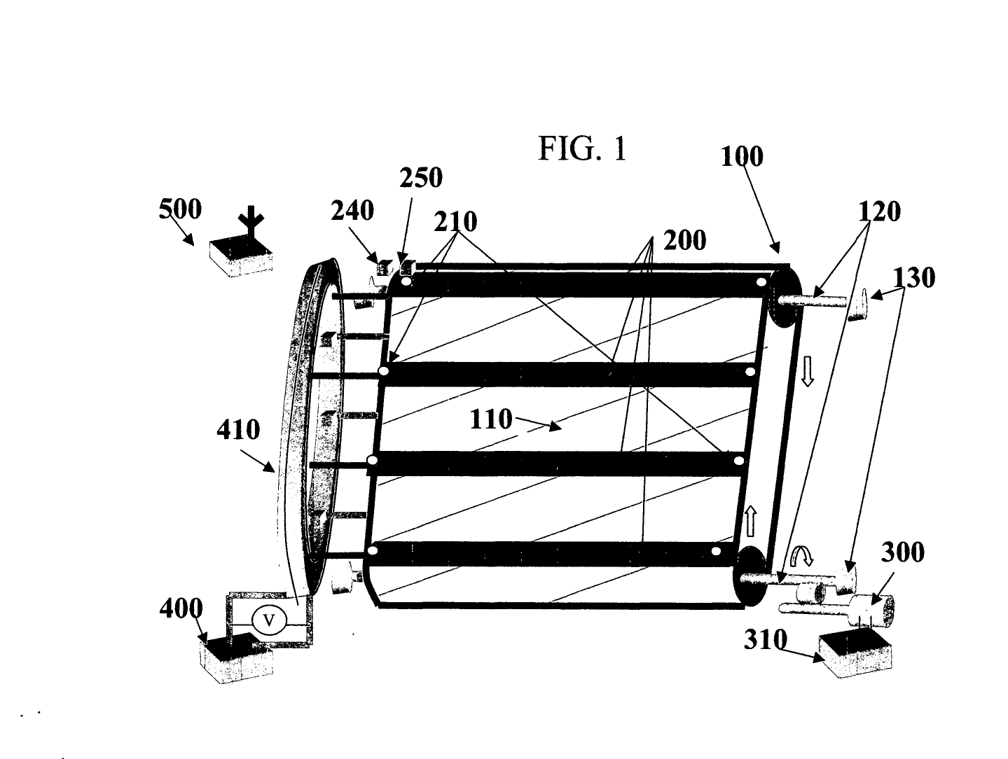

In accordance with FIG. 1, the display apparatus comprises of a conveyor system (100), a plurality of display stripes (200) being harnessed on the conveyor base (110), a controlled motor drive assembly (300), a power supply (400) for the display stripes, and a display controller system (500).

The conveyor system (100) further comprises of a flexible conveyor base (110) that wraps around two or more rotating shafts (120). Although FIG. 1 shows the use of two shafts, two or more shafts can be used. The conveyor base is made of flexible materials, in the form of a one contiguous piece of object, a bell-type object, or a “net” type of construction so as to provide a contiguous movement around the shafts. The rotating shafts are further stationary mounted with bearings (130) that are commonly used in mechanical devices. When the shafts being driven by a motor assembly (300), the conveyor base (110) travels around the shafts as used in commercially available conveyor systems. The rotation is controlled by a motor controller unit (310) to a desired speed. Such a motor controller design is also widely available commercially and the design can be done with an ordinary skilled electronic controller engineer.

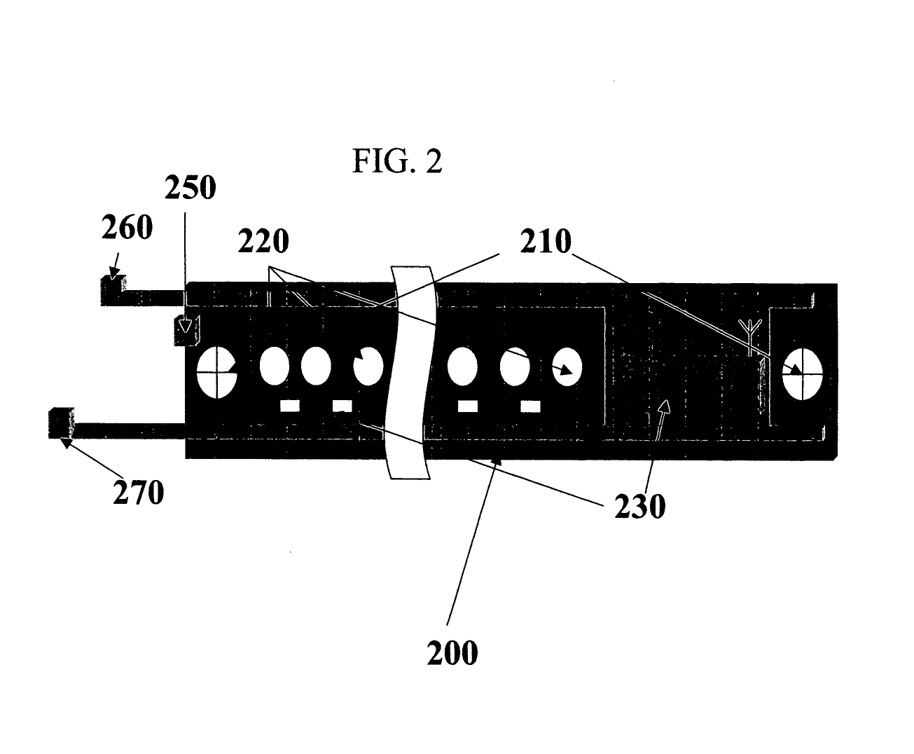

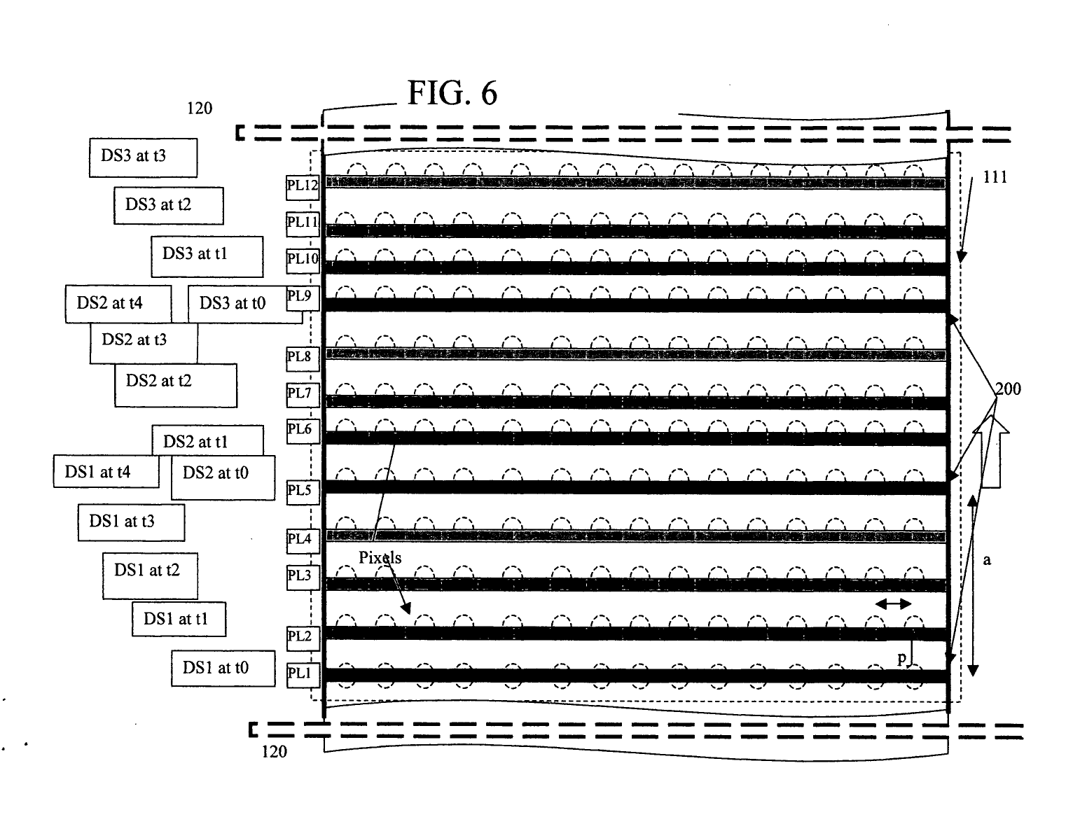

A plurality of display stripess (200) are equal-spatially harnessed on the conveyor based (110) via mounting points (210). The number of mounting point (210) on each display stripes (200) and the physical method of mounting are not restricted, so long as they provide means of secured and durable attachment to the conveyor base (110). As shown in FIG. 1, the longitudinal side of the display stripes (210) is harnessed on the conveyor base 110 parallel to the shafts (120). This is the desirable orientation though it is not required as long as the stripes are not perpendicular to the shafts. FIG. 2 is a more detailed depiction of the display stripes (200). The base material of the stripes can be a printed circuit board, though other materials can be used. A plurality of light emitting elements (220), such as LEDs, and herein being referred to as LEDs, are mounted along the longitudinal orientation of 200. In such an arrangement, each display stripe (200) can be viewed as a 1×“n” resolution of display, where “n” is the number of LEDs on the stripe referred to as horizontal resolution and “1” refers to one line resolution on vertical direction. Although it is possible to construct a display stripe of “k” by “n” matrix of display stripes and still using the same principle of the present invention, “k” is set to one in the preferred embodiment. As shown in FIG. 5, on the display stripe (200), there are additional electronic circuitries (230) that comprise of solid-state memories and controllers (231 and 232) to provide means to control the desired on and off of the LEDs, as well as a communication circuitry (233) that communicate wirelessly with the display controller system (500). Control circuitries, such as using a micro-controller with programmable algorithms are commonly used in today's display electronics. Wireless methods commonly used include but not limited to RF and infrared technologies. The display apparatus also comprises of a transducer pair—one stationary actuator 240 for the apparatus, and one sensor 250 on each display stripe. When a display stripe travels with the conveyor base 110 and passes at the location of 250, an electronic signal is triggered. This information is fed back to abovementioned controller circuitry (230) for use in controlling the display. Although other coupler devices can be used, a commonly used transducer pair is a photo coupler with 240 being an LED and 250 being a photo sensor.

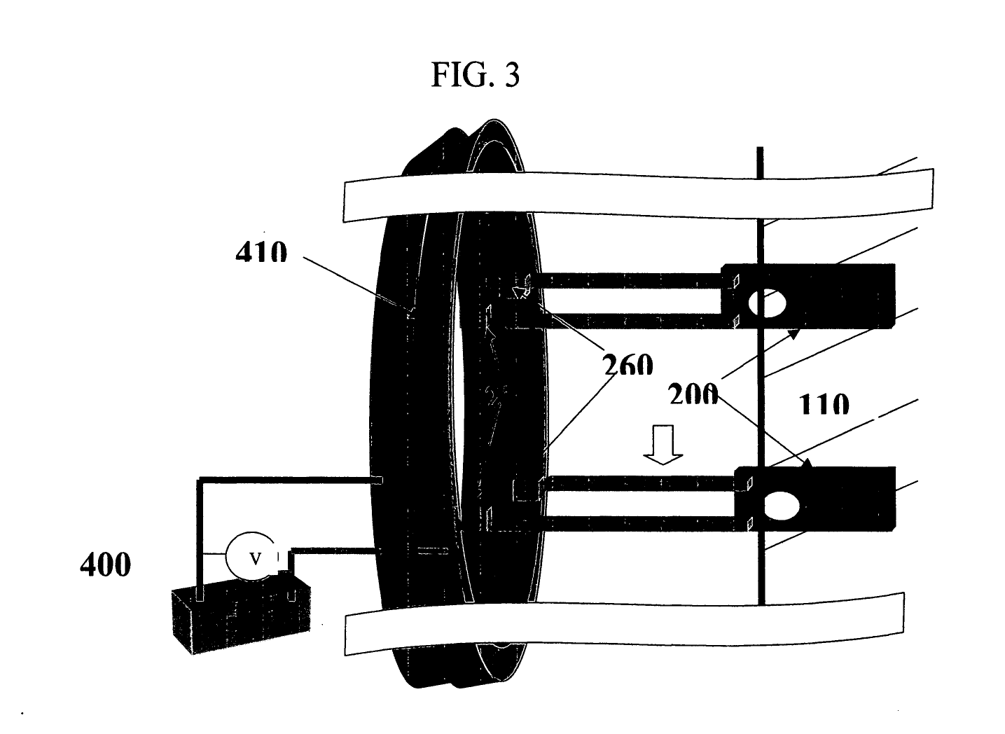

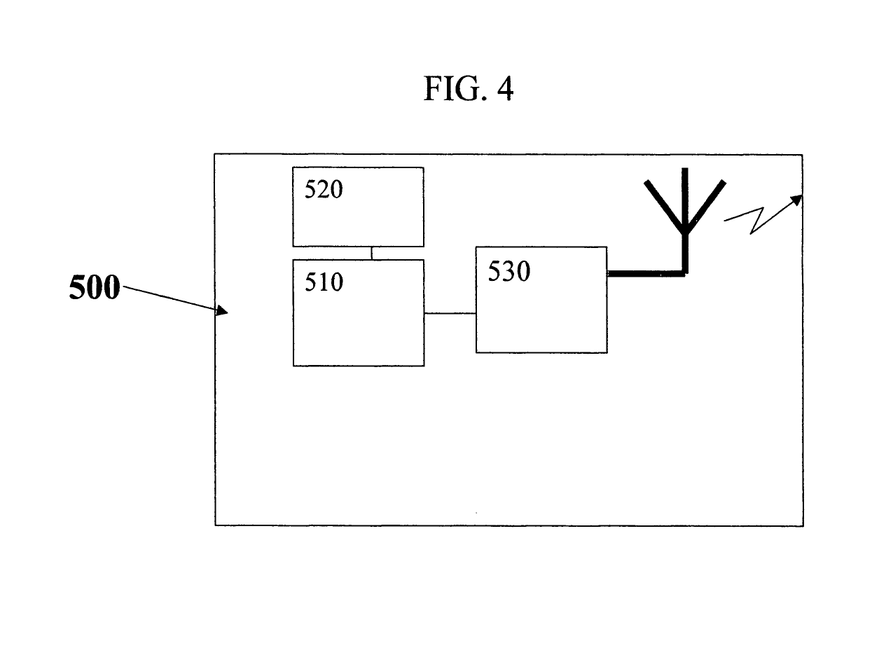

In accordance with FIG. 1, the display apparatus further includes a power supply, 400, having an anode and a cathode used to supply continuous electricity to the display stripes while the stripes (200) are traveling with the conveyor base (110). The commonly used method to maintain electronic contacts to a moving object is by using brush contact assembly, such as ones in brush electric motors. In such an assembly, a stationary brush made of graphite material makes a contact on a rotating copper contact so as to achieve low friction and low electric resistance. A preferred embodiment of the present invention is depicted in FIG. 3. In this embodiment, each display stripe has an anode and cathode electrodes (260 and 270) made of graphite material and extruding from the printed circuit board 200. The stationary side of the contact 310 comprises of two electrically insolated rings made of conductive materials, such as copper. 410 has a shape that tracks the cross-section shape of the conveyor base (110). Each of the rings is electrically attached to the power supply anode and cathode, respectively. 260 and 270 make continuous electrical contacts with 300 while the display stripe (200) travels with the conveyor base (110) around the shafts (120), thereby constant power is supplied to all display stripes on the conveyor base (110). FIG. 3b depicts an alternative embodiment of making electrical contacts between the power supply (400) and the display stripes (200). In this embodiment, a rotator with two electrically insolated contact rings R1 and R2 are mounted concentrically on a shaft 120. A stator also has two electrical contacts, S1 and S2 connected to the power supply 400 and making contacts with R1 and R2, respectively, while R1 and R2 rotates with the shaft 120. The conveyor base (110) is embedded with two stripes (E1 and E2) made of flexible electrical conducting materials around 110 and overlay on R1 and R2, respectively. Each display stripe (200) has two contact points (C1 and C2) making contact with E1 and E2 respectively. Thereby, when the display stripes (200) travel around the shafts (120), constant electrical contacts are made between the stripes and the power supply via C1&C2, E1&E2, R1&R2, and S1&S2, respectively.

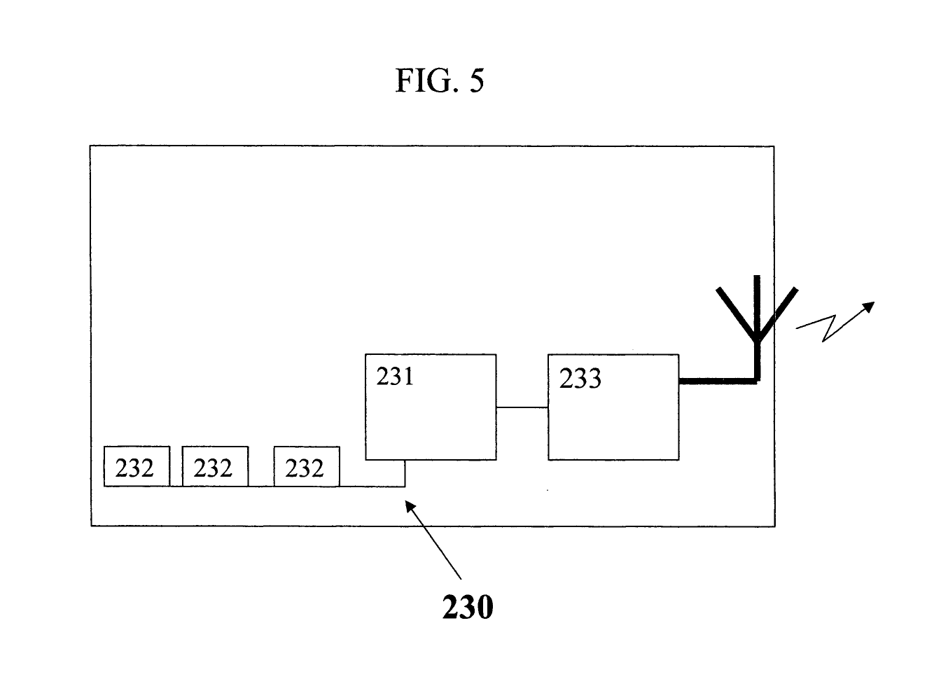

In accordance with FIG. 1, the present invention further comprises of a display controller system 500. This system includes a number of functional blocks, as depicted in FIG. 4. It includes a video processing unit 510 that processes information from varies sources, such as from video inputs, computer generated graphic inputs, etc. The controller system also includes a wireless communication unit 530 that is capable of communicating the processed data from 510 wirelessly to the circuitry in 233 on display stripes (200). Controller system 500 further includes a motor sensing and control unit 520 that provide means to coordinate between the displayed information and the motor speed driven by the motor controller 310. Such a control process is described with further details below.

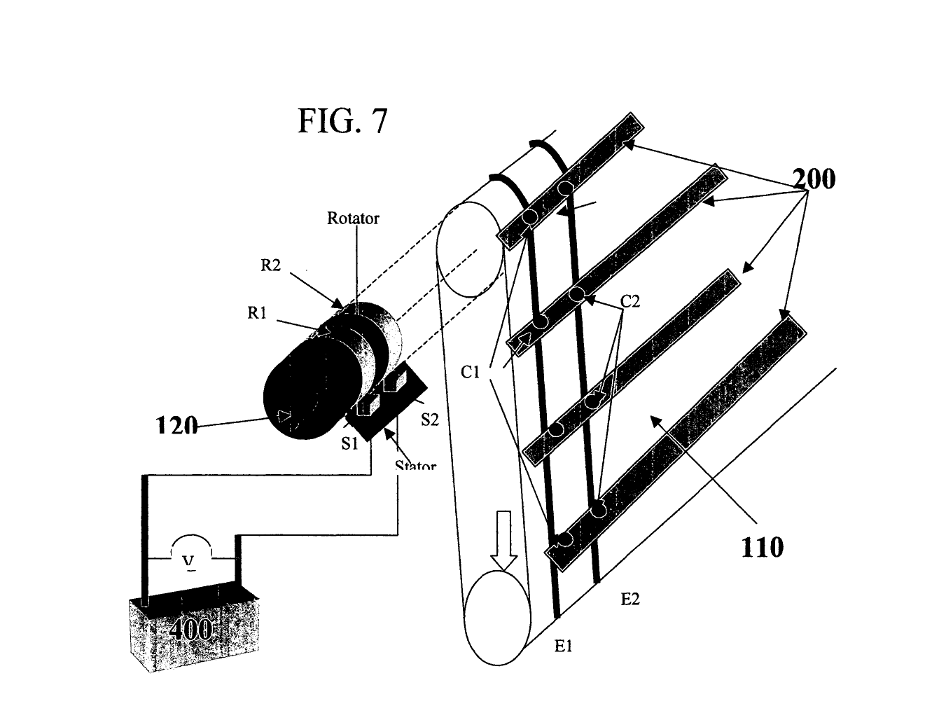

The present invention prescribes a method of electronic display using a coordination of mechanical scanning together with precise controlling of LEDs so as to achieve using fewer LEDs than otherwise the resolution commands. FIG. 6 illustrates the time-location relations of the mechanism in this method. A display surface (111) is an area on the conveyor base (110) confined between two adjacent shafts (120) consisting of a number of display stripes (200). The steady image rendered on this display surface (111) is made of a matrix of “m” by “n” pixels (112), where “m” is the vertical resolution and “n” is the horizontal resolution for the simplicity of description, and both being integers as number of pixels. The pixel pitch size “p” is the measurement between each adjacent pixel location. Although it is not a requirement, “p” is the same in horizontal and vertical directions for simplicity of description. The display stripes (200) overlay on selected pixel locations at a given moment and the distance between any two stripes is “a”, where “a” is made to be two or more times of “p”. The LEDs on each display stripe can be viewed as a “1” by “n” matrix and also has a horizontal pixel pitch size of “p”. When the display stripes (200) travel with the conveyor base and going through each image horizontal pixel lines, they display the corresponding pixel information. The time-location description of this process is demonstrated in the FIG. 6 with three display stripes annotated as DS1, DS2, and DS3 as the following and assuming “a” equals four times of “p”:

At time t0, display stripes (DS1, DS2, DS3) are at location PL1, PL5, PL9, respectively and display the corresponding information of the first frame for those pixel lines. PL1˜PL12 annotate the consecutive horizontal lines of pixels;

At time t1, DS1, DS2, and DS3 travels to new locations at PL2, PL6 and PL10, respectively and display the corresponding information of the first frame for those lines;

At time t2, DS1, DS2, and DS3 travels to new locations at PL3, PL7 and PL11, respectively and display the corresponding information of the first frame for those lines;

At time t3, DS1, DS2, and DS3 travels to new locations at PL4, PL8 and PL12, respectively and display the corresponding information of the first frame for those lines;

At time t4, DS1 travels to PL5, DS2 travels to PL9, and DS3 travels to PL13 (not shown in FIG. 6), respectively and display the corresponding information of the second frame for those lines, and so on.

Such a process continues so that all horizontal pixel lines are displayed by the display stripes with their corresponding information in a frame by frame fashion.

Due to persistence of vision, human eyes perceive the above process as fully steady images so long as the above process takes place at a sufficient frame rate, usually described by frames per second or frame rate. It is well known that when display is at 30 frames/s, human eyes will perceive a steady image. In the present invention, the conveyor base traveling speed “s” is to be controlled in order to achieve a desirable frame rate “f” based on the following relations:
“s”=“f”×“p”×(“a”+“p”).
In another word, the line speed, “s” required for the conveyor base to travel to achieve a desired frame rate “f” is “f” multiplied by the pixel pitch size “p” and multiplied by a “scanning factor” defined by the ratio of “a” and the pixel pitch size, “p”.

In accordance with FIG. 1, a display surface is an area confined as the conveyor base (110) with display stripes (200) between two adjacent shafts. In an apparatus with two shafts, there could be a maximum of two such display faces. In case of three shafts, the maximum number of such display face is three, and so on. The apparatus in the present invention can further include many techniques today in used for conventional displays, such as an enclosure with transparent openings to confine the display viewing area while providing physical protections, shields to deflect sunlight to improve contrast ratios, etc. to further improve the viewing quality. These kinds of techniques do not interfere with the principle operation of the current invention and can be adopted as needed.

Although the invention has been explained in relation to its preferred embodiment, it is to be understood that many other possible modifications and variations can be made without departing from the spirit and scope of the invention as hereinafter claimed.

We claim:

1. A method displaying electronic images, comprising:
Forming a contiguous conveyor base wrapped around at least two rotating shafts and means to control traveling speed of said conveyor base through controlling rotating speed of said shafts;
Harnessing a plurality of display stripes equal-spatially on said conveyor base and parallel to each other and axially aligned with said shafts, wherein each said display stripe comprising of a plurality of regularly arranged light emitting elements and other electronic control and memory elements;
Driving said shafts to rotate at a speed thereby moving said conveyor surface and said display stripes around said shafts;
Making continuous electrical contact between said display stripes and at least one stationary power supply and means providing continuous power from the power supply to said display stripes while said stripes are traveling;
Rendering images on at least one planar display surface confined on said conveyor base and between adjacent said shafts with a line resolution at least two times the number of said display stripes on said surfaces.

2. A method according to claim 1 further comprises of using at least one transducer pair comprising of one actuator and one sensor, wherein one of which situating on said conveyor base surface, and the other stationary mounted, and means for said electronic elements on said display stripes to cause information displayed controlled by said sensed signals generated by said transducer pair;

3. Said transducer pair according to claim 2 further comprises of using a photo emitting element as said actuator and a photo sensing element as said sensor;

4. A method according to claim 1 further comprising of using a stationary situated display controller system that processes the desired display information and wireless means to communicate with said electronic control and memory elements on said display stripes;

5. Said wireless method according to claim 4 further comprises of using radio frequency to transmit and receive desirable information data;

6. A display apparatus comprising:
A conveyor base wrapped around at least two rotary shafts stationary situated and means to control traveling speed of said conveyor base by controlling the rotation speed of said shaft;
A plurality of display stripes regularly spaced being harnessed on said conveyor base parallel to each other and axially arranged, wherein each said display stripe comprising of a plurality of regularly arranged light emitting elements and other electronic control and memory elements;
A plurality of electrodes on said display stripes and means to make continuous electrical contacts to at least one stationary situated power supply while said stripes travel with said conveyor base as said shafts rotate at a speed;
At least one planar display surface confined as said conveyor base area between two adjacent said shafts comprising of a subset of said moving display stripes, wherein said electronic control and memory elements on said display stripes contain means to display information on said moving display elements to cause display line resolution at least two times the number of said display stripes in said area.

7. A display apparatus according to claim 6 further comprises of a stationary situated display controller system that processes the desired display information and wireless means to communicate with said electronic control and memory elements on said display stripes;

8. Said wireless method according to claim 7 comprises of using radio frequency to transmit and receive desirable information data;

9. A display apparatus according to claim 6 further comprises of at least one transducer pair comprising of one actuator and one sensor, wherein one of which situating on said conveyor base surface, and the other stationary mounted, and means for said electronic elements on said display stripes to cause information displayed controlled by said sensed signals generated by said transducer pair;

10. Said transducer pair according to claim 9 comprises of a photo emitting element as said actuator and a photo sensing element as said sensor;

11. A display apparatus comprising:
A conveyor base wrapped around at least two rotary shafts stationary situated and means to control traveling speed of said conveyor base by controlling the rotation speed of said shaft;
A plurality of display stripes regularly spaced being harnessed on said conveyor base parallel to each other and axially arranged, wherein each said display stripe comprising of a plurality of regularly arranged light emitting elements and other electronic control and memory elements;
A plurality of electrodes on said display stripes and means to make continuous electrical contacts to at least one stationary situated power supply while said stripes travel with said conveyor base as said shafts rotate at a speed;
At least one planar display surface confined as said conveyor base area between two adjacent said shafts comprising of a subset of said moving display stripes, wherein said electronic control and memory elements on said display stripes contain means to display information on said moving display elements to cause display line resolution at least two times the number of said display stripes in said area.

12. A display apparatus according to claim 11 further comprises of a stationary situated display controller system that processes the desired display information and wireless means to communicate with said electronic control and memory elements on said display stripes;

13. Said wireless method according to claim 12 comprises of using radio frequency to transmit and receive desirable information data;

14. A display apparatus according to claim 13 further comprises of at least one transducer pair comprising of one actuator and one sensor, wherein one of which situating on said conveyor base surface, and the other stationary mounted, and means for said electronic elements on said display stripes to cause information displayed controlled by said sensed signals generated by said transducer pair;

15. Said transducer pair according to claim 14 comprises of a photo emitting element as said actuator and a photo sensing element as said sensor;
